(19) United States
(12) Patent Application Publication
(10) Pub. No.: US 2023/0189805 A1
(43) Pub. Date: Jun. 22, 2023

(54) MULTI-SOLVENT INSECTICIDAL COMPOSITIONS INCLUDING SULFOXIMINE

(71) Applicant: CLARKE MOSQUITO CONTROL PRODUCTS, INC., St. Charles, IL (US)

(72) Inventors: Laeticia Leroy Rene-Boisneuf, Naperville, IL (US); Andrea Levey, Naperville, IL (US); Kattie Lynne Morris, Glendale Heights, IL (US); Yemi Susan BULLEN-MCCLAIN, Vernon Hills, IL (US)

(21) Appl. No.: 17/998,907

(22) PCT Filed: May 14, 2021
(86) PCT No.: PCT/US2021/032577

§ 371 Date: Nov. 15, 2022

Related U.S. Application Data
(60) Provisional application No. 63/025,725, filed on May 15, 2020.

(51) Int. Cl. A01N 43/40; A01N 25/30; A01N 25/06; A01P 7/04

(52) U.S. Cl. CPC A01N 43/40; A01N 25/30; A01N 25/06; A01P 7/04

(57) ABSTRACT

Insecticidal compositions may include an active ingredient, a solvent system, a first surfactant, and a second surfactant. The active ingredient may include a sulfoximine. The solvent system may include a polyalkylene carbonate solvent and a second solvent. The first surfactant may be an alkoxylated alcohol. The second surfactant may be an ethoxy lated castor oil. Methods for insect control may include contacting a population of insects with an insecticidal composition. In some aspects, insecticidal compositions are particularly suited for use against mosquitos.

### CROSS-REFERENCE TO RELATED APPLICATION(S)

The present application is related to and claims the priority benefit of U.S Provisional Patent Application No. 63/025,725, filed May 15, 2020, the entire contents of which are incorporated herein by reference.

### TECHNICAL FIELD

The present disclosure relates to insecticidal compositions and methods of use. More particularly, insecticidal compositions disclosed and contemplated herein include a sulfoximine and a multi-solvent system.

### INTRODUCTION

Treatment of adult mosquitoes is an important defense against mosquito-borne illnesses. Typically, adult mosquito populations are controlled with application of pesticides. One common technique uses Ultra Low Volume (ULV) technology, sometimes referred to as cold fogging. The pesticide is applied with specialized spray equipment mounted in aircraft, on the back of trucks, or even carried by hand. With this technique, aerosols are released to drift through a target zone. Chemical concentrates most often are used, and even if diluted, volumes of material used remain low. Preferably, the aerosol should persist in the air column for an appreciable length of time at suitable droplet densities to contact a flying mosquito. Typically, the aerosol is generally only effective while the droplets remain airborne.

### SUMMARY

The present disclosure relates to insecticidal compositions and methods of use. In one aspect, an insecticidal composition is disclosed. The insecticidal composition may include an active ingredient including a sulfoximine, a solvent system including a polyalkylene carbonate solvent and a second solvent, a first surfactant that may be an alkoxylated alcohol, and a second surfactant that may be an ethoxylated castor oil.

In another aspect, a method for insect control is disclosed. The method may include contacting a population of insects with an insecticidal composition. The insecticidal composition may include an active ingredient including a sulfoximine, a solvent system including a polyalkylene carbonate solvent and a second solvent, a first surfactant that may be an alkoxylated alcohol, and a second surfactant that may be an ethoxylated castor oil.

There is no specific requirement that a material, technique or method relating to insecticidal compositions include all of the details characterized herein to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 shows experimental laboratory data for mortality rates of Aedes aegypti mosquitos 48 hours after being contacted with samples including different amounts of an ethoxylated caster oil surfactant.

FIG. 2 shows experimental laboratory data for mortality rates of Aedes aegypti mosquitos 48 hours after being contacted with samples including different amounts of an alkoxylated alcohol surfactant.

FIG. 3 shows experimental laboratory data for mortality rates of Aedes aegypti mosquitos 48 hours after being contacted with samples including different amounts of alkoxylated alcohol surfactant and/or ethoxylated caster oil surfactant.

FIG. 4 shows experimental laboratory data for evaporation rates of samples including different amounts of alkoxylated alcohol surfactant and/or ethoxylated caster oil surfactant.

FIG. 5 shows a portion of the experimental laboratory data for evaporation rates shown in FIG. 4.

### DETAILED DESCRIPTION

Compositions, methods, and techniques disclosed and contemplated herein relate to insecticidal compositions. Insecticidal compositions disclosed herein include a sulfoximine as an active ingredient, which is soluble in few solvents. It was discovered that single-solvent systems including a sulfoximine as the active ingredient did not display satisfactory efficacy. Accordingly, insecticidal compositions disclosed herein include multi-solvent systems with suitable solvents.

It was also discovered that certain species of insects were susceptible to insecticidal compositions including certain surfactants but not other surfactants. In some instances, it was discovered that an amount of active ingredient in insecticidal compositions could be decreased, without losing efficacy, by including one or more suitable surfactants. Accordingly, insecticidal compositions disclosed herein may also include one or more surfactants. Exemplary insecticidal compositions may have a suitable physical profile and be effective against various species of mosquitoes whether applied aerially or via ground ULV applications.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

“Mosquito” is understood to refer to any specie of the roughly 3,500 species of the insect that is commonly associated with and given the common name “mosquito.” Mosquitoes span 41 insect genera, including the non-limiting examples of Aedes, Culex, Anopheles (carrier of malaria), Coquillettidia, and Ochlerotatus.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Exemplary Insecticidal Compositions

Exemplary insecticidal compositions may include various components at differing amounts. Exemplary insecticidal compositions may be designed as formulations that can be applied with hand-held, truck-mounted, and aerial ULV sprayers. In some instances, exemplary insecticidal compositions may be ready-to-use formulations that can be applied without dilution. Various aspects of exemplary insecticidal compositions are discussed below.

A. Various Components of Exemplary Insecticidal Compositions

Exemplary insecticidal compositions include one or more active ingredients and a solvent system. Typically, exemplary insecticidal compositions may also include one or more surfactants. Exemplary insecticidal compositions may comprise, consist essentially of, or consist of, one or more components disclosed and contemplated herein.

Active ingredients suitable for use in exemplary insecticidal compositions are sulfoximines. A commercially available example of a sulfoximine is sulfoxaflor, available as Isoclast™ sold by Corteva Agriscience (Wilmington, Del.). A chemical structure of sulfoxaflor is shown below:

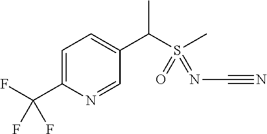 [SMILES: CC(c1ccc(C(F)(F)F)nc1)S(C)(=O)=NC#N]

Exemplary insecticidal compositions have a solvent system that includes multiple solvents. Typically, example solvent systems use two solvents.

A first solvent is usually a polyalkylene carbonate solvent. In some instances, the polyalkylene carbonate solvent may be a C₂₋₄ alkylene carbonate. For example, the polyalkylene carbonate solvent may be ethylene carbonate, propylene carbonate, or butane carbonate.

Suitable second solvents are typically esters. Example second solvents may include tributyl O-acetylcitrate (ACBT). Example second solvents may include methyl 5-(dimethylamino)-2-methyl-5-oxopentanoate, commercially available as Rhodiasolv PolarClean (Solvay S. A., Brussels, Belgium). Example second solvents may include triethyl citrate.

Exemplary insecticidal compositions may include one or more surfactants. Example insecticidal compositions may include an alkoxylated alcohol (also referred to as alcohol alkoxylates) as a surfactant. Commercially available examples of alkoxylated alcohols include the Atplus™ (a C₉-C₁₁ alcohol ethoxylate/propoxylate) product line available from Croda (Edison, N.J.), which includes Atplus™ 245.

Insecticidal compositions including two surfactants may include an ethoxylated castor oil as a surfactant. Commercially available examples of ethoxylated castor oils include the Alkamuls™ product line from Solvay (Brussels, Belgium), which includes Alkamuls EL-719.

Exemplary insecticidal compositions may include a knockdown agent. In some instances, the knockdown agent may include one or more pyrethroids. Exemplary pyrethroids include one or more of etofenprox, permethrin, prallethrin, resmethrin, sumithrin, allethrin, alpha-cypermethrin, bifenthrin, beta-cypermethrin, cyfluthrin, cypermethrin, deltamethrin, esfenvalerate, etofenprox, lamdba-cyhalothrin, or zeta-cypermethrin.

B. Example Amounts of Various Components of Exemplary Insecticidal Compositions

Exemplary insecticidal compositions may include different amounts of various components. For instance, exemplary insecticidal compositions may include an active ingredient at 1.0 wt % (where wt % is percentage by weight) to 6.0 wt %. In various embodiments, a total amount of active ingredient present in exemplary insecticidal compositions may be 1.0 wt % to 5.5 wt %; 1.5 wt % to 6.0 wt %; 2.0 wt % to 6.0 wt %; 2.5 wt % to 5.5 wt %; 1.0 wt % to 5.0 wt %; 1.0 wt % to 4.0 wt %; 2.0 wt % to 5.0 wt %; 3.0 wt % to 6.0 wt %; 1.0 wt % to 3.0 wt %; 2.0 wt % to 4.0 wt %; 3.0 wt % to 5.0 wt %; 4.0 wt % to 6.0 wt %; 1.0 wt % to 2.0 wt %; 2.0 wt % to 3.0 wt %; 3.0 wt % to 4.0 wt %; 4.0 wt % to 5.0 wt %; or 5.0 wt % to 6.0 wt %. In various embodiments, the total amount of active ingredient in exemplary insecticidal compositions may be at least 1.0 wt %; at least 2.0 wt %; at least 2.5 wt %; at least 3.0 wt %; at least 4.0 wt %; or at least 5.0 wt %. In various embodiments, the total amount of active ingredient in exemplary insecticidal compositions may be no greater than 6.0 wt %; no greater than 5.5 wt %; no greater than 5.0 wt %; no greater than 4.0 wt %; no greater than 3.0 wt %; no greater than 2.0 wt %.

Exemplary insecticidal compositions may include various ratios of solvents. For instance, exemplary insecticidal compositions may include a ratio of polyalkylene carbonate solvent to second solvent of from 0.67:1 to 1.5:1. In various embodiments, exemplary insecticidal compositions may include a ratio of polyalkylene carbonate solvent to second solvent of 0.67:1; of 0.81:1; of 0.9:1; of 0.96:1; of 1:1; of 1.04:1; of 1.1:1; of 1.22:1; or of 1.5:1.

Exemplary insecticidal compositions may include various amounts of solvent, where the solvent comprises polyalkylene carbonate solvent and second solvent. For instance, exemplary insecticidal compositions may include 70 wt % to 92 wt % solvent. In various embodiments, a total amount of solvent in exemplary insecticidal compositions may be 70.0 wt % to 90.0 wt %; 74 wt % to 90.0 wt %; 70.0 wt % to 80.0 wt %; 80.0 wt % to 90.0 wt %; 73.0 wt % to 77.0 wt %; 79.0 wt % to 83.0 wt %; or 86.0 wt % to 92.0 wt %. In various embodiments, a total amount of solvent in exemplary insecticidal compositions may be at least 70.0 wt %; at least 74.0 wt; at least 80.0 wt %; at least 85.0 wt %; or at least 88.0 wt %. In various embodiments, a total amount of solvent in exemplary insecticidal compositions may be no greater than 92.0 wt %; no greater than 90.0 wt %; no greater than 85.0 wt %; no greater than 82.0 wt %; no greater than 76.0 wt %; or no greater than 73.0 wt %.

Exemplary insecticidal compositions may include various amounts of alkoxylated alcohol surfactant, such as from 1.0 wt % to 20.0 wt %. In various embodiments, a total amount of alkoxylated alcohol surfactant present in insecticidal compositions may be 1.0 wt % to 18.0 wt %; 3.0 wt % to 20.0 wt %; 5.0 wt % to 15.0 wt %; 2.0 wt % to 7.0 wt %; 3.0 wt % to 8.0 wt %; 4.0 wt % to 9.0 wt %; 5.0 wt % to 10.0 wt %; 1.0 wt % to 4.0 wt %; 4.0 wt % to 7.0 wt %; 7.0 wt % to 10.0 wt %; 10.0 wt % to 13.0 wt %; 13.0 wt % to 16.0 wt %; 2.0 wt % to 4.0 wt %; 4.0 wt % to 6.0 wt %; 6.0 wt % to 8.0 wt %; 8.0 wt % to 10.0 wt %; 5.0 wt % to 6.0 wt %; 6.0 wt % to 7.0 wt %; 7.0 wt % to 8.0 wt %; 8.0 wt % to 9.0 wt %; or 9.0 wt % to 10.0 wt %. In various embodiments, a total amount of alkoxylated alcohol surfactant present in insecticidal compositions may be at least 1.0 wt %; at least 3.0 wt %; at least 5.0 wt %; at least 6.0 wt %; at least 7.0 wt %; at least 8.0 wt %; at least 9.0 wt %; at least 10.0 wt %; at least 13.0 wt %; at least 16.0 wt %; or at least 19.0 wt %. In various embodiments, a total amount of alkoxylated alcohol surfactant present in insecticidal compositions may be no greater than 20.0 wt %; no greater than 17.0 wt %; no greater than 14.0 wt %; no greater than 11.0 wt %; no greater than 10.0 wt % no greater than 9.0 wt %; no greater than 8.0 wt %; no greater than 7.0 wt %; no greater than 6.0 wt %; no greater than 4.0 wt %; or no greater than 2.0 wt %.

Exemplary insecticidal compositions may include various amounts of ethoxylated castor oil surfactant, such as from 1.0 wt % to 20.0 wt %. In various embodiments, a total amount of ethoxylated castor oil surfactant present in insecticidal compositions may be 1.0 wt % to 18.0 wt %; 3.0 wt % to 20.0 wt %; 5.0 wt % to 15.0 wt %; 2.0 wt % to 7.0 wt %; 3.0 wt % to 8.0 wt %; 4.0 wt % to 9.0 wt %; 5.0 wt % to 10.0 wt %; 1.0 wt % to 4.0 wt %; 4.0 wt % to 7.0 wt %; 7.0 wt % to 10.0 wt %; 10.0 wt % to 13.0 wt %; 13.0 wt % to 16.0 wt %; 2.0 wt % to 4.0 wt %; 4.0 wt % to 6.0 wt %; 6.0 wt % to 8.0 wt %; 8.0 wt % to 10.0 wt %; 5.0 wt % to 6.0 wt %; 6.0 wt % to 7.0 wt %; 7.0 wt % to 8.0 wt %; 8.0 wt % to 9.0 wt %; or 9.0 wt % to 10.0 wt %. In various embodiments, a total amount of ethoxylated castor oil surfactant present in insecticidal compositions may be at least 1.0 wt %; at least 3.0 wt %; at least 5.0 wt %; at least 6.0 wt %; at least 7.0 wt %; at least 8.0 wt %; at least 9.0 wt %; at least 10.0 wt %; at least 13.0 wt %; at least 16.0 wt %; or at least 19.0 wt %. In various embodiments, a total amount of ethoxylated castor oil surfactant present in insecticidal compositions may be no greater than 20.0 wt %; no greater than 17.0 wt %; no greater than 14.0 wt %; no greater than 11.0 wt %; no greater than 10.0 wt % no greater than 9.0 wt %; no greater than 8.0 wt %; no greater than 7.0 wt %; no greater than 6.0 wt %; no greater than 4.0 wt %; or no greater than 2.0 wt %

Exemplary insecticidal compositions may include various ratios of surfactants. For instance, exemplary insecticidal compositions may include a ratio of alkoxylated alcohol surfactant to ethoxylated castor surfactant of from 0.25:1 to 1.18:1. In various embodiments, exemplary insecticidal compositions may include a ratio of alkoxylated alcohol surfactant to ethoxylated castor surfactant of 0.25:1; 0.3:1; 0.4:1 0.5:1; of 0.6:1; of 0.7:1; of 0.8:1; of 0.9:1; of 0.95:1; or 0.98:1.0; of 1:1; of 1.02:1; of 1.05:1; of 1.1:1; or of 1.18:1.

When present, exemplary insecticidal compositions may include 0.25 wt % to 1.5 wt % knockdown agent. In various embodiments, exemplary insecticidal compositions may include 0.25 wt % to 1.5 wt %; 0.5 wt % to 1.0 wt %; 0.25 wt % to 0.75 wt %; 0.75 wt % to 1.5 wt %; 0.6 wt % to 0.9 wt %; or 0.7 wt % to 0.8 wt % knockdown agent. In various embodiments, exemplary insecticidal compositions may include at least 0.25 wt %; at least 0.5 wt %; at least 0.7 wt %; at least 1.0 wt %; or at least 1.25 wt % knockdown agent. In various embodiments, exemplary insecticidal compositions may include no greater than 1.5 wt %; no greater than 1.25 wt %; no greater than 1.0 wt %; no greater than 0.8 wt %; or no greater than 0.5 wt % knockdown agent.

C. Physical Characteristics of Exemplary Insecticidal Compositions

Exemplary insecticidal compositions may have a suitable physical profile and be effective against various species of mosquitoes whether applied aerially or via ground ULV applications. Typically, it is desirable for the insecticidal composition to persist in the air column for an appreciable length of time at suitable droplet densities to contact a flying mosquito. Characteristics that affect the desired profile include, but are not limited to, non-volatile fraction, density and evaporation rate.

Exemplary insecticidal compositions can be characterized by various physical attributes, such as density, particle size when applied, and non-volatile fraction. Exemplary insecticidal compositions may have a density of from about 1.0 g/mL to about 1.2 g/mL. In various embodiments, exemplary insecticidal compositions may have a density of from 1.0 g/mL to 1.2 g/mL; from 1.0 g/mL to 1.1 g/mL; or from 1.1 g/mL to 1.2 g/mL.

In exemplary embodiments, an insecticidal composition may have a non-volatile fraction from 50 wt % to 99 wt %; from 50 wt % to 75 wt %; or from 50 wt % to 60 wt %. In exemplary embodiments, an insecticidal composition may have a non-volatile fraction of more than about 50 wt %, or more than about 60 wt %, or more than about 75 wt %, or more than about 80 wt %. In exemplary embodiments, an insecticidal composition may have a non-volatile fraction of less than about 100 wt %, or less than about 90 wt %, or less than about 75 wt %, or less than about 60 wt %.

In exemplary embodiments, the insecticidal composition can be formulated for application or delivery as an aerosol or a fog wherein the insecticidal composition allows for the formation of droplets having an average diameter of less than 30 μm. Typically, droplets formed of exemplary insecticidal compositions may have an average diameter of about 1 μm to about 30 μm; about 5 μm to about 25 μm; or about 8 μm to about 22 μm. Suitable insecticidal compositions for such a formulation typically should have a viscosity that allows for the insecticidal composition to atomize, but not be so thick as to clog the nozzle. Such viscosities can vary and be readily determined by one of skill in the art; however, a non-limiting common minimum viscosity is about 1 centistokes (cts).

### III. Exemplary Methods of Making

Exemplary insecticidal compositions disclosed and contemplated herein can be generally prepared by any appropriate manufacturing processes and using any appropriate manufacturing equipment such as is known in the art. Exemplary insecticidal compositions can be prepared by combining various components in an appropriate vessel (considering vessel size, amount of insecticidal composition to be made and reactivity of components) with mixing (e.g., stirring) until a uniform or homogeneous insecticidal composition is achieved. Various composition components can be added sequentially, with stirring between each addition to ensure dissolution and/or dispersion of the previous component.

In some instances, a solvent system is prepared before adding any additional components. For instance, a polyalkylene carbonate solvent may be combined with a second solvent to generate a solvent system. After mixing the polyalkylene carbonate solvent and the second solvent, an active ingredient may be added to the solvent system. After mixing the active ingredient in the solvent system, one or more surfactants may be added and mixed.

### IV. Exemplary Methods Use

Exemplary insecticidal compositions disclosed and contemplated herein can be used in methods for insect control, where the methods may include contacting an insect or a population of insects with an amount of any of the insecticidal compositions disclosed and contemplated herein. In some embodiments, methods of use may include contacting a mosquito with an amount of an insecticidal composition comprising, consisting essentially of, or consisting of an active ingredient including a sulfoximine, a solvent system including a polyalkylene carbonate solvent and a second solvent, a first surfactant that is an alkoxylated alcohol, and a second surfactant that is an ethoxylated caster oil.

In some embodiments, administration of the insecticidal composition provides droplets having an average diameter of less than 30 μm. In some embodiments, the insecticidal composition is applied as an aerosol or fog, and wherein the aerosol or fog contacts the population of insects. In some embodiments, the population of insects comprises mosquitos from one or more of the following genera: Aedes sp., Culex sp., and Anopheles sp.

In some embodiments, the methods described herein can comprise any known route, apparatus, and/or mechanism for the delivery or application of the compositions and formulations. In some embodiments, the method comprises a sprayer. Traditional pesticide sprayers in the pest control markets are typically operated manually or electrically or are gas-controlled and use maximum pressures ranging from 15 to 500 psi generating flow rates from 5 gpm to 40 gpm.

In some embodiments, the methods disclosed herein comprise the use of the compositions and/or formulations in combination with any low volume environmental pest control device(s) such as, for example, ultra low volume (ULV) machines. Such combinations are useful in methods for mosquito control as well as other flying insects (e.g., flies, gnats, flying ants, sand fleas, and the like) wherein contacting the insect with a low volume of the composition is possible and/or desirable. ULV machines use low volume of material, for example, at rates of about one gallon per hour (or ounces per minute), and typically utilize artificial wind velocities such as from, for example, an air source (e.g., pump or compressor) to break down and distribute the composition/formulation into a cold fog (e.g., having average droplet particle sizes of about 1-30 μm). Any standard ground ULV equipment used for adult mosquito control such as, for example, a system including a (CETI) aerosol generator can be used in the methods described herein. A general ULV system includes a tank for the composition (e.g., insecticide), a transport system (e.g., a pump or pressurized tank), a flow control device, and a nozzle that atomizes the composition. Typically, ULV machines do not compress droplets. Rather, they often use a venture siphoning system, and can induce an artificial energizing of the droplets by adding an electrical current to the liquid (e.g., through the use an electrode located at the application tip. (See, e.g., U.S. Pat. No. 3,516,608 (Bowen, et al.) incorporated herein by reference.)

In some embodiments, contacting a population of insects with insecticidal compositions disclosed and contemplated herein results in a mortality rate of at least 70% against each of Aedes sp., Culex sp., and Anopheles sp. after 48 hours. In some embodiments, contacting a population of insects with insecticidal compositions disclosed and contemplated herein results in a mortality rate of at least 80% against each of Aedes sp., Culex sp., and Anopheles sp. after 48 hours. In some embodiments, contacting a population of insects with insecticidal compositions disclosed and contemplated herein results in a mortality rate of at least 80% against each of Aedes sp., Culex sp., and Anopheles sp. after 24 hours. In some embodiments, contacting a population of insects with insecticidal compositions disclosed and contemplated herein results in a mortality rate of at least 90% against each of Aedes sp., Culex sp., and Anopheles sp. after 48 hours. In some embodiments, contacting a population of insects with insecticidal compositions disclosed and contemplated herein results in a mortality rate of at least 90% against each of Aedes sp., Culex sp., and Anopheles sp. after 24 hours.

In some embodiments, contacting a population of insects with insecticidal compositions disclosed and contemplated herein results in a one-hour knockdown rate of at least 70% against each of Aedes sp., Culex sp., and Anopheles sp. In some embodiments, contacting a population of insects with insecticidal compositions disclosed and contemplated herein results in a one-hour knockdown rate of at least 80% against each of Aedes sp., Culex sp., and Anopheles sp. In some embodiments, contacting a population of insects with insecticidal compositions disclosed and contemplated herein results in a one-hour knockdown rate of at least 90% against each of Aedes sp., Culex sp., and Anopheles sp.

### V. Experimental Examples

Experimental examples were conducted and the results are discussed below.

A. Laboratory Experimental Analysis of Solvents

In a laboratory environment, different co-solvents were tested with sulfoxaflor and propylene carbonate. Specifically, insecticidal compositions were prepared with sulfoxaflor, propylene carbonate and one of the following co-solvents: (i) Rhodiasolv PolarClean, (ii) tributyl O-acetylcitrate, and (iii) polyethylene glycol (PEG). Each sample included a 1:1 ratio of propylene carbonate and co-solvent. Then the samples were applied to Culex sp. mosquitos. Mortality rates of each sample are provided below in Table 1.

TABLE 1
Samples tested with different co-solvents
against Culex sp. mosquitos

| | 1-hour | 24 hour | 48 hour | 72 hour |
|---|---|---|---|---|
| Co-solvent | knockdown | mortality | mortality | mortality |
| PolarClean | 1% | 82% | 98% | 99% |
| tributyl O- | 20% | 99% | 100% | 100% |
| acetylcitrate | | | | |
| polyethylene | 2% | 41% | n/a | n/a |
| glycol (PEG) | | | | |

The results shown in Table 1 appear to show there is an impact of a second solvent on efficacy, which is unexpected because the co-solvent does not participate in the dissolution of sulfoxaflor. Without being bound to a particular theory, the co-solvent appears, however, to aid in penetration of the insecticide.

B. Laboratory Experimental Analysis of Surfactants

Various amounts of different surfactants were evaluated to determine possible impacts on efficacy. In one set of trials, different amounts of sulfoxaflor were tested with and without a surfactant (Pluronic L92 from BASF). The samples included a 1:1 ratio of propylene carbonate and tributyl O-acetylcitrate. Then the three different formulations were tested against Culex sp. mosquitos, and the results are shown in Table 2 below.

TABLE 2
Samples tested with and without surfactant
against Culex sp. mosquitos

| Sulfoxaflor | Surfactant | 1-hour | | | |
|---|---|---|---|---|---|
| content | content | knock- | 24 hour | 48 hour | 72 hour |
| (wt. %) | (wt. %) | down | mortality | mortality | mortality |
| 1% | None | 18% | 62% | 94% | 98% |
| 0.5% | None | 0% | 27% | 76% | 86% |
| 0.5% | 20% | 2% | 64% | 92% | n/a |

The results in Table 2 indicate that adding a surfactant to the composition improved efficacy. Additionally, the insecticidal composition including surfactant displayed similar efficacy as the insecticidal composition including twice as much active ingredient, but without the surfactant.

C. Laboratory Experimental Analysis of Surfactant Amounts

In a laboratory environment, various amounts of different surfactants were evaluated to determine possible impacts on efficacy.

To observe behavior equivalent to a ULV application in an outdoor environment, a spray chamber was used, which would require each sample to be diluted to 10% of its original content. For example, a sample containing 5 wt % active ingredient for outdoor field study should be tested in a laboratory at 0.5 wt % active ingredient content.

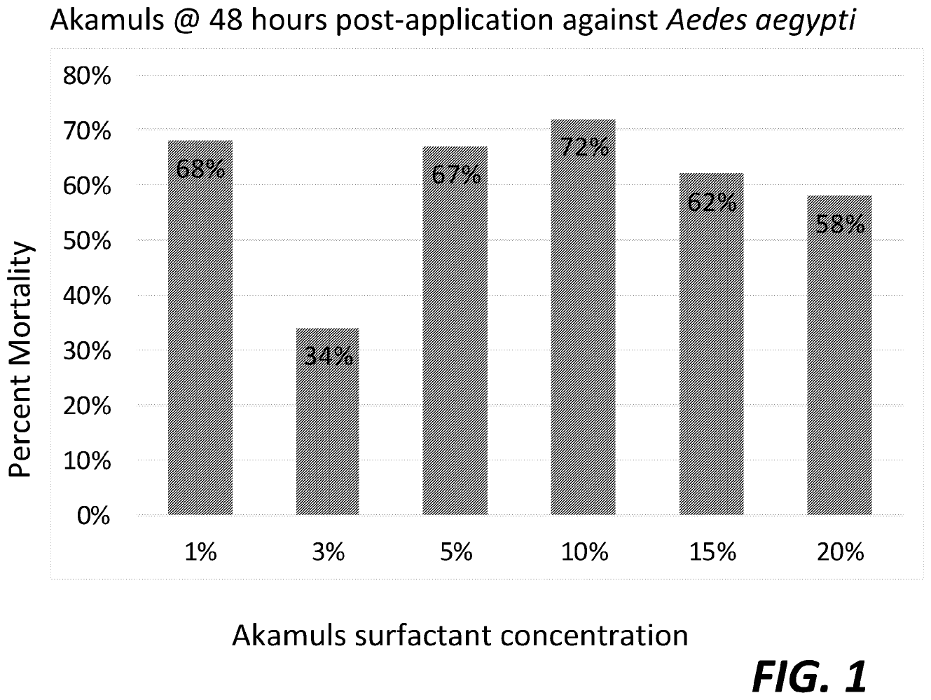

In one set of trials, differing amounts of Alkamuls™ were added to different samples of insecticidal compositions including 0.5 wt % sulfoxaflor, propylene carbonate and triethyl citrate, where the propylene carbonate and triethyl citrate were present in a 1:1 ratio. Aedes aegypti mosquitos were contacted with the samples and percent mortality was determined after 48 hours. Results are shown in FIG. 1 and indicate a non-linear response with a content of 10 wt % for Alkamuls™ by itself.

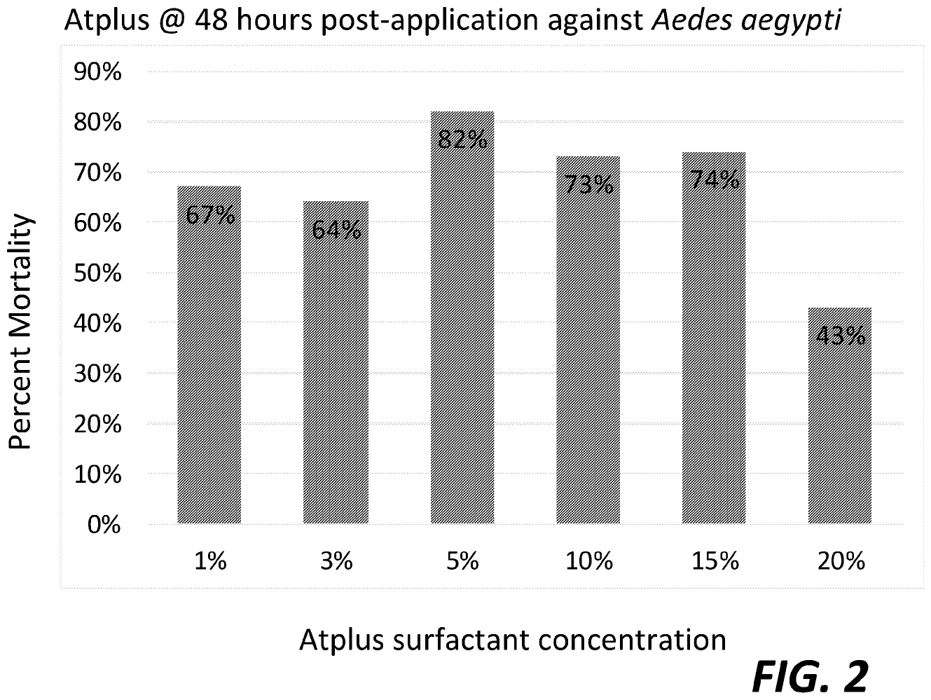

In another set of trials, differing amounts of Atplus were added to different samples of insecticidal compositions including 0.5 wt % sulfoxaflor, propylene carbonate and triethyl citrate, where the propylene carbonate and triethyl citrate were present in a 1:1 ratio. Aedes aegypti mosquitos were contacted with the samples and percent mortality was determined after 48 hours. Results are shown in FIG. 2 and indicate that a higher response was observed at 5 wt % surfactant and a non-linear response.

In another set of trials, varying amounts of Alkamuls™ and Atplus surfactants were added to different samples of insecticidal compositions including 0.5 wt % sulfoxaflor, propylene carbonate and triethyl citrate, where the propylene carbonate and triethyl citrate were present in a 1:1 ratio. The surfactants were added after the sulfoxaflor was mixed with the propylene carbonate and triethyl citrate. The different samples are described below in Table 3.

TABLE 3
Sample compositions tested against Aedes aegypti. Each
composition included 0.5 wt % sulfoxaflor, propylene
carbonate and triethyl citrate, where the propylene carbonate
and triethyl citrate were present in a 1:1 ratio

| Sample Number | Alkamuls (wt. %) | Atplus (wt. %) |
|---|---|---|
| #1 | 10 | 5 |
| #2 | 5 | 10 |
| #3 | 10 | 10 |
| #4 | 10 | 0 |
| #5 | 0 | 10 |
| #6 | 7.5 | 2.5 |
| #7 | 0 | 0 |
| #8 | 10 | 10 |
| #9 | 5 | 5 |
| #10 | 2.5 | 2.5 |
| #11 | 0 | 0 |
| #12 | 5 | 0 |
| #13 | 7.5 | 7.5 |
| #14 | 5 | 5 |
| #15 | 0 | 5 |

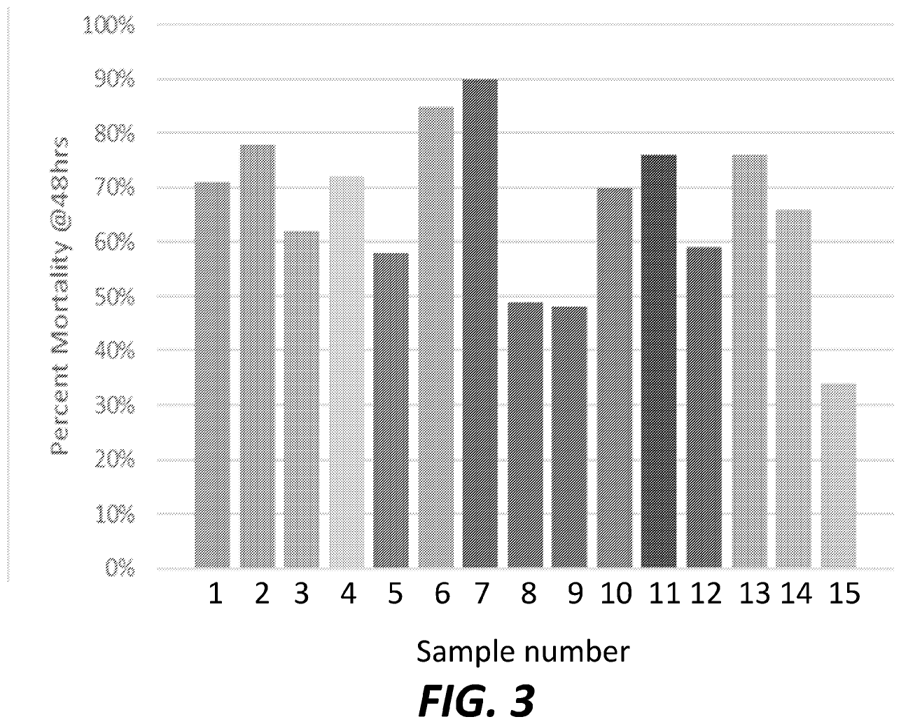

Results for the fifteen different samples after 48 hours are shown in FIG. 3. The impact on Aedes sp. mortality varied depending on the overall surfactant content and the ratio between the two surfactant families.

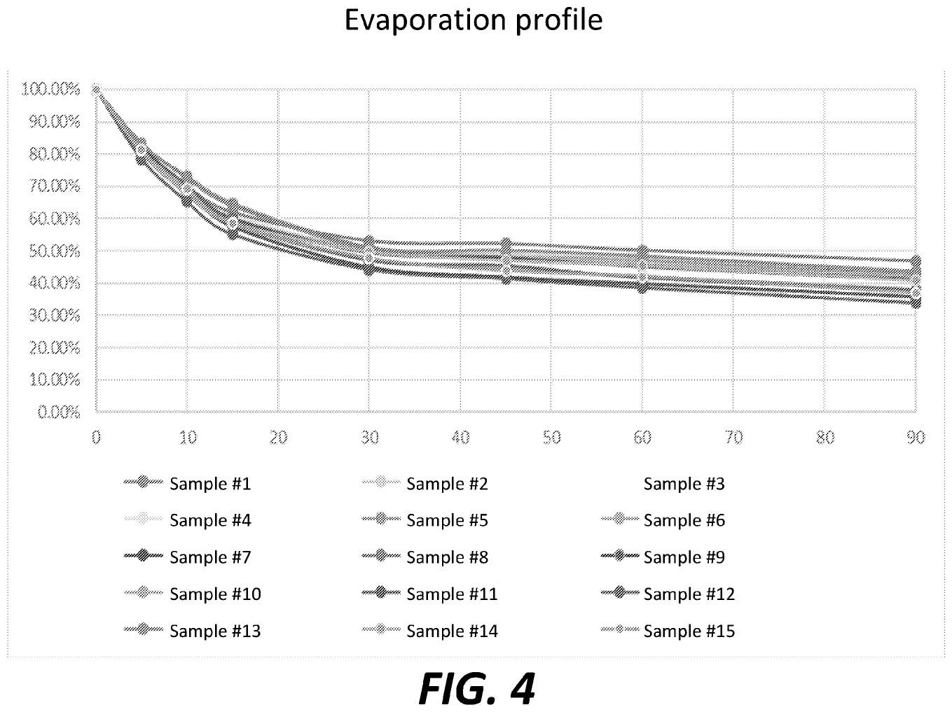

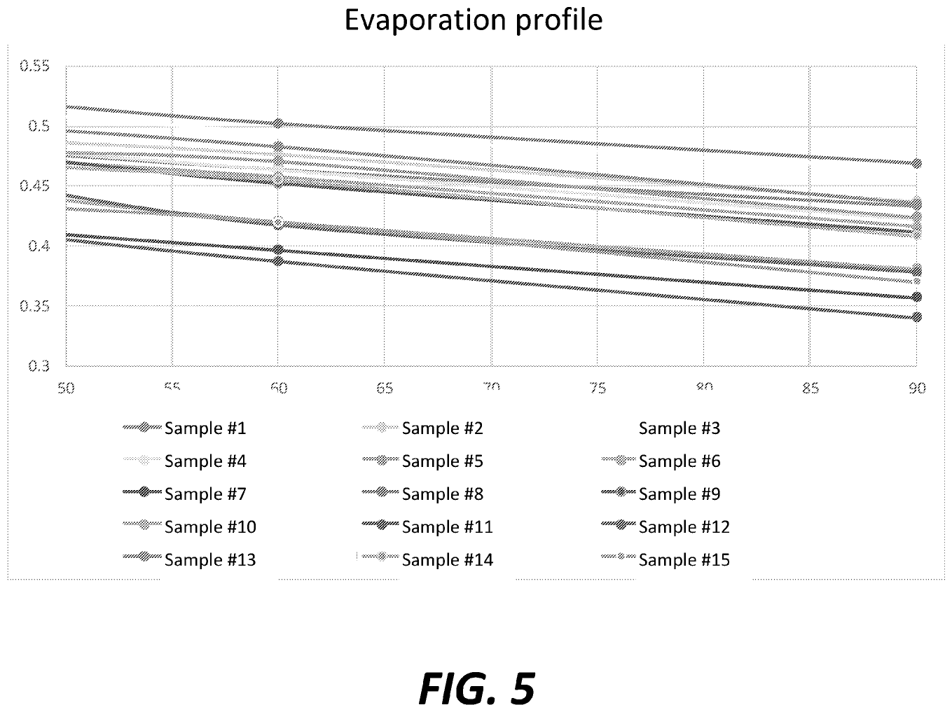

Evaporation profiles over 90 minutes for the samples shown in Table 3 are provided in FIG. 4. During the tests, a sample of known weight was placed in an oven heated to 90° C. and weight loss was monitored over time. FIG. 5 is an exploded view of a portion of FIG. 4, showing evaporation rates between 50 and 90 minutes. FIG. 4 and FIG. 5 show the range of evaporation rate (initial drop) and non-volatile fraction (plateau) for each of the fifteen samples.

D. Laboratory Analysis of Exemplary Insecticidal Composition

In a laboratory environment, various physical parameters were evaluated for an exemplary insecticidal composition, Composition A, having the constituents as provided in Table 4 below.

TABLE 4
Composition of exemplary insecticidal Composition
A evaluated for physical parameters

| Components | Amount (wt. %) |
|---|---|
| Sulfoxaflor | 3.00% |
| Prallethrin | 0.75% |
| Atplus 245 | 7.50% |
| Alkamuls EL-719 | 7.50% |
| Propylene Carbonate | 40.63% |
| Triethyl Citrate | 40.63% |

Table 5 below shows the results of various tests performed on Composition A of Table 4. Certain physical properties were determined following guidelines provided by the Office of Prevention, Pesticides, and Toxic Substances (OPPTS), and the relevant OPPTS test numbers are also shown in Table 5. Spread factor was determined by microscopy. Miscibility with mineral was determined by mixing the same volume of sample and oil, shaking vigorously and letting the sample rest over time to observe any phase separation. Evaporation rate was determined by monitoring the weight loss at a certain temperature over 90 minutes. Viscosity was measured using a Brookfield viscometer. Flash point was measured using a Setaflash instrument. Density was measured using a pycnometer.

TABLE 5
Experimental results for various tests
performed on Composition A of Table 4

| | Notes | OPPTS 830.XXX |
|---|---|---|
| Formula Stability | | |
| A.I Storage Stability | Pass - <5% degradation | 830.6317 |
| | for CR3138 and <10% | |
| | for CR3060 | |
| Color | Yellow | 830.6302 |
| Odor | Mild ester, sweet | 830.6303 |
| PH | 7.08 | 830.7000 |
| Formula Properties | | |
| Viscosity | 20° C. = 18.72 cP, | 830.7100 |
| | 40° C. = 9.63 cP | |
| Spread Factor | 0.666 | |
| Miscibility with mineral | Immiscible at 50:50 ratio | |
| Flash Point (flammability) | 137.5° C. | 830.6315 |
| Density | 1.185 g/mL (9.889 | 830.7300 |
| | lb/gal) at 20° C. | |
| Evaporation rate | 42.87% volatile fraction | |

E. Field Trials

Field trials were conducted for three insecticidal compositions, shown in Table 6 below.

TABLE 6
Insecticidal compositions used during field trials

| | Amount (wt. %) | | |
|---|---|---|---|
| Components | Composition A | Composition B | Composition C |
| Sulfoxaflor | 3.00 | 5.00 | 5.00 |
| Prallethrin | 0.75 | 0.50 | 0.50 |
| Atplus 245 | 7.50 | 5.00 | — |
| Alkamuls EL-719 | 7.50 | — | 20.00 |
| Propylene Carbonate | 40.63 | 44.75 | 37.25 |
| Triethyl Citrate | 40.63 | 44.75 | 37.25 |

The objective of this study was to determine the efficacy of Composition A, Composition B, and Composition C in an open field caged trial against adult Aedes aegypti, Culex quinquefasciatus, and/or Anopheles quadrimaculatus mosquitoes. For Composition A, the study was conducted in Lake Wales, Fla.; Boone County, Ill.; Baytown, Tex.; Bartow, Fla.; and Beaufort, S.C. For Composition B and Composition C, the study was conducted in Lake Wales, Fla.

The Compositions were applied using the Cougar ultra-low-volume (ULV) cold aerosol spray equipment marketed by Clarke Mosquito Control Products, Inc. (St. Charles, Illinois). The trials were conducted at an application rate of 1.0 oz./acre for Compositions A and C, and at an application rate of 1.25 oz./acre for Composition B. Composition B and Composition C were tested against adult caged female Aedes aegypti, Culex quinquefasciatus, and Anopheles quadrimaculatus. Composition A was tested against Anopheles quadrimaculatus, Aedes aegypti, and Culex quinquefasciatus, although only results against Anopheles are presented here

Mosquitoes used during the study were three- to five-day old adult females Aedes aegypti, Culex quinquefasciatus, and Anopheles quadrimaculatus. Pupae were provided by the Clarke insectary for the bioassay, the mosquitoes were reared and emerged in cages stored in a secure, temperature-controlled location. They were fed a 10% to 20% sugar water solution throughout the study period. The mosquitoes were visually inspected for accurate species identification and viability.

Approximately 15-25 mosquitoes were mouth-aspirated using aspirators with HEPA-filters into standard cylindrical cardboard spray cages (14.4 cm diameter) or holding cages. (Townzen, K. R. et al., 1973). Mosquito cages were then placed in an enclosed container and stored in a secure environment until placed in field for evaluation.

The treatment site consisted of an open grassy field large enough for a 1000-foot spray tangent and a 300-foot swath. Rotary slide impingers with Teflon-coated slides were placed on stakes adjacent to spray cages at 100, 200 and 300 feet of each replicate. Spray cages were placed on five-foot stakes, (three cages per stake, one cage per species), at an angle perpendicular to the spray line. Stakes were placed at 100, 200 and 300 feet down-wind at a 90° angle from the spray line. Cages were placed in one column 100 feet apart. A total of nine spray cages per species were used for each replicate, and one control cage per species was used per application rate (three replicates).

Teflon coated slides were used to sample the spray cloud at 100, 200, and 300 feet down wind of the spray truck tangent using Leading Edge Slide Impingers. Droplets were collected in each replicate and analyzed using a spread factor of 0.71 (Anderson, C. H. et al., 1971; May, K. Ret al., 1950).

A Kestrel meteorological station was placed on site at a 30 foot elevation at the start of the trials to confirm temperature inversion. An additional Kestrel meteorological station was placed at five feet, including wind direction, wind speed, temperature, and relative humidity. Data was recorded at one-minute intervals after initial insecticide release (Christensen, P. W. et al., 1972).

A total of three replications per application rate were made for this trial. Following each spray, the treated mosquitoes were allowed ten minutes of exposure and then transferred to clean holding cages for knockdown and mortality monitoring.

Mosquitoes were monitored at one hour for knockdown and 12, 24, 48, 72 and 96 hours for mortality. Mosquitoes were considered knocked down if they remained moribund after receiving a slight puff of air from the observer. For the mortality ratings, any movement by a mosquito required the observer to record the individual as alive.

Untreated control cages were used per three replicates. Control cages were placed upwind from the spray tangent during treatments to protect from contamination and were handled in a manner identical to treated mosquitoes.

Table 7 below shows results for application of Composition B.

TABLE 7
Field screen data for Composition B, where “KD” is knockdown, “Mort”
is mortality and “M&M” is mortality plus moribund

| 1-hr | 12-hr | | 24-hr | | 48-hr | | 72-hr | |
|---|---|---|---|---|---|---|---|---|
| KD | Mort | M&M | Mort | M&M | Mort | M&M | Mort | M&M |

Aedes

| | | | | | | | | | |
|---|---|---|---|---|---|---|---|---|---|
| 100 ft | 92% | 38% | 72% | 56% | 68% | 75% | 77% | 94% | 97% |
| 200 ft | 97% | 41% | 58% | 62% | 72% | 76% | 80% | 76% | 79% |
| 300 ft | 74% | 26% | 53% | 47% | 54% | 62% | 62% | 65% | 65% |
| Control | | 0% | | 0% | | 0% | | 5% | |

Anopheles

| | | | | | | | | | |
|---|---|---|---|---|---|---|---|---|---|
| 100 ft | 85.9% | 14% | 69% | 44% | 82% | 65% | 68% | 72% | 75% |
| 200 ft | 69.9% | 14% | 58% | 34% | 55% | 56% | 66% | 68% | 75% |
| 300 ft | 72.9% | 10% | 48% | 22% | 42% | 41% | 45% | 52% | 59% |
| Control | | 0% | | 0% | | 1% | | 38% | |

Culex

| | | | | | | | | | |
|---|---|---|---|---|---|---|---|---|---|
| 100 ft | 98.6% | 41% | 71% | 75% | 86% | 90% | 90% | 88% | 90% |
| 200 ft | 98.5% | 22% | 46% | 63% | 77% | 80% | 83% | 86% | 88% |
| 300 ft | 84.2% | 16% | 34% | 37% | 46% | 84% | 87% | 91% | 91% |
| Control | | 0.0% | | 0.0% | | 0.0% | | 27.9% | |

Table 8 below shows results for application of Composition C.

TABLE 8
Field screen data for Composition C, where “KD” is knockdown, “Mort”
is mortality and “M&M” is mortality plus moribund

| 1-hr | 12-hr | | 24-hr | | 48-hr | | 72-hr | |
|---|---|---|---|---|---|---|---|---|
| KD | Mort | M&M | Mort | M&M | Mort | M&M | Mort | M&M |

Aedes

| | | | | | | | | | |
|---|---|---|---|---|---|---|---|---|---|
| 100 ft | 99% | 66% | 85% | 79% | 87% | 91% | 93% | 91% | 91% |
| 200 ft | 100% | 73% | 90% | 87% | 91% | 91% | 93% | 93% | 93% |
| 300 ft | 100% | 69% | 81% | 75% | 79% | 82% | 85% | 82% | 85% |
| Control | | 1% | | 1% | | 1% | | 1% | |

Anopheles

| | | | | | | | | | |
|---|---|---|---|---|---|---|---|---|---|
| 100 ft | 92% | 38% | 87% | 72% | 89% | 82% | 90% | 89% | 91% |
| 200 ft | 97% | 24% | 91% | 72% | 88% | 80% | 88% | 89% | 92% |
| 300 ft | 86% | 22% | 67% | 62% | 75% | 71% | 79% | 77% | 80% |
| Ctrl | | 0% | | 2% | | 2% | | 2% | |

Culex

| | | | | | | | | | |
|---|---|---|---|---|---|---|---|---|---|
| 100 ft | 98% | 15% | 24% | 93% | 96% | 95% | 96% | 98% | 98% |
| 200 ft | 100% | 73% | 90% | 87% | 91% | 91% | 93% | 93% | 93% |
| 300 ft | 91% | 52% | 98% | 80% | 93% | 91% | 98% | 97% | 98% |
| Ctrl | | 0.4% | | 0.4% | | 73.3% | | 77.1% | |

Droplet size (VIVID) and drop densities (drops per square centimeter) were determined for each distance following spray of Composition A. Results were averaged and are shown in Table 9.

TABLE 9
Average droplet size (VMD) and drop densities for Composition
A at various field sites (excluding the control)

| | | Lake | Boone | | | Beaufort, |
|---|---|---|---|---|---|---|
| | | Wales, | County, | Baytown, | Bartow, | South |
| | | Florida | Illinois | Texas | Florida | Carolina |
| VMD | 100 ft | 9.20 | 14.07 | 9.30 | 14.22 | 20.58 |
| (μm) | 200 ft | 9.73 | 14.28 | 9.44 | 12.36 | 17.77 |
| | 300 ft | 9.12 | 14.03 | 9.66 | 11.65 | 16.21 |
| Drop | 100 ft | 1646.92 | 317.06 | 552.22 | 709.13 | 1061.47 |
| densities | 200 ft | 1258.35 | 421.03 | 431.20 | 482.53 | 712.67 |
| (drops per | 300 ft | 1291.67 | 425.30 | 592.05 | 544.85 | 693.70 |
| square | | | | | | |
| centimeter) | | | | | | |

Table 10 below shows results for application of Composition A to Anopheles.

TABLE 10
Median results for application of Composition A to Anopheles at various sites,
where “KD” is knockdown, “Mort” is mortality, and “M&M” is mortality plus moribund

| 1 hr | 24 hr | | 48 hr | | 72 hr | | 96 hr | |
|---|---|---|---|---|---|---|---|---|
| KD | Mort | M and M | Mort | M and M | Mort | M and M | Mort | M and M |

Lake Wales

| | | | | | | | | | |
|---|---|---|---|---|---|---|---|---|---|
| 100 ft | 100% | 76% | 96% | 90% | 100% | 95.2% | 100% | 100% | 100% |
| 200 ft | 100% | 90% | 100% | 95% | 100% | 95.2% | 100% | 100% | 100% |
| 300 ft | 100% | 77% | 96% | 88% | 100% | 96.2% | 100% | 100% | 100% |
| Control | 0% | 4% | 4% | 5% | 5% | 7.4% | 7% | 9% | 9% |

Boone County

| | | | | | | | | | |
|---|---|---|---|---|---|---|---|---|---|
| 100 ft | 100% | 70% | 96% | 92% | 100% | 96% | 100% | 96% | 100% |
| 200 ft | 100% | 72% | 97% | 100% | 100% | 100% | 100% | 100% | 100% |
| 300 ft | 100% | 73% | 96% | 96% | 100% | 96% | 100% | 96% | 100% |
| Control | 0% | 0% | | 0% | | 5% | | 5% | |

Baytown

| | | | | | | | | | |
|---|---|---|---|---|---|---|---|---|---|
| 100 ft | 100% | 70% | 100% | 83% | 96% | 91.3% | 100% | 100% | 100% |
| 200 ft | 100% | 64% | 100% | 85% | 94% | 87.0% | 94% | 94% | 94% |
| 300 ft | 100% | 50% | 100% | 81% | 95% | 86.4% | 95% | 92% | 95% |
| Control | 0% | 0% | | 0% | | 3.7% | | 4% | |

Bartow

| | | | | | | | | | |
|---|---|---|---|---|---|---|---|---|---|
| 100 ft | 100% | 82% | 95% | 92% | 100% | 91.7% | 100% | 92% | 100% |
| 200 ft | 100% | 78% | 96% | 95% | 96% | 95.0% | 96% | 95% | 96% |
| 300 ft | 100% | 76% | 96% | 86% | 96% | 83.3% | 96% | 83% | 96% |
| Control | 0% | 4% | 4% | 5% | 5% | 5.3% | 5% | 5% | 5% |

Beaufort

| | | | | | | | | | |
|---|---|---|---|---|---|---|---|---|---|
| 100 ft | 100% | 92% | 100% | 100% | 100% | 100.0% | 100% | 100% | 100% |
| 200 ft | 100% | 76% | 100% | 91% | 96% | 91.3% | 96% | 91% | 96% |
| 300 ft | 100% | 65% | 96% | 86% | 100% | 86.4% | 100% | 86% | 100% |
| Control | 0% | 0% | 0% | 5% | 0% | 5.3% | 0% | 5% | 0% |

Table 11 below, shows overall mortality rates for application of Composition A applied to Anopheles, excluding missed stations (defined as when the slide next to the station shows no droplet, which means the cloud missed the station).

TABLE 11
Overall mortality, excluding missed stations,
for Composition A against Anopheles

| | | Lake Wales | Belvidere | Baytown | Bartow | Beaufort | All |
|---|---|---|---|---|---|---|---|
| All | 100 ft | 91.9% | 95.8% | 86.9% | 92.0% | 100.0% | 92.6% |
| | 200 ft | 94.0% | 91.4% | 85.9% | 91.0% | 87.9% | 89.1% |
| | 300 ft | 96.4% | 88.2% | 85.5% | 87.7% | 86.5% | 88.5% |
| | Control | 8.9% | 6.3% | 2.9% | 8.5% | 7.4% | 6.7% |
| | Overall | 94.0% | 91.4% | 86.1% | 90.1% | 91.5% | 89.7% |
| Median | 100 ft | 95.5% | 95.7% | 91.3% | 91.7% | 100.0% | 100.0% |
| | 200 ft | 97.6% | 100.0% | 94.4% | 95.0% | 91.3% | 95.1% |
| | 300 ft | 100.0% | 96.0% | 86.4% | 86.4% | 86.4% | 90.9% |
| | Control | 7.4% | 5.0% | 3.7% | 5.3% | 5.3% | 5.0% |
| | Overall | 96.2% | 95.7% | 87.0% | 90.9% | 100.0% | 95.2% |

The foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. An insecticidal composition comprising:
an active ingredient including a sulfoximine;
a solvent system including a polyalkylene carbonate solvent and a second solvent;
a first surfactant that is an alkoxylated alcohol; and
a second surfactant that is an ethoxylated castor oil.

2. The insecticidal composition according to claim 1, further comprising a knockdown agent comprising a pyrethroid.

3. The insecticidal composition according to claim 2, comprising 0.25 wt % to 1.5 wt % knockdown agent.

4. The insecticidal composition according claim 1, wherein the insecticidal composition includes, by weight percentage, 1% to 20% first surfactant and 1% to 20% second surfactant.

5. The insecticidal composition according to claim 1, wherein the sulfoximine is sulfoxaflor.

6. The insecticidal composition according to claim 1, wherein the second solvent is tributyl O-acetylcitrate.

7. The insecticidal composition according to claim 1, wherein the second solvent is triethyl citrate.

8. The insecticidal composition according to claim 1, wherein the polyalkylene carbonate is propylene carbonate.

9. The insecticidal composition according to claim 1, wherein the insecticidal composition includes, by weight percentage, 5% to 10% first surfactant and 5% to 10% second surfactant.

10. The insecticidal composition according to claim 9, wherein the first surfactant and the second surfactant are present in the insecticidal composition in a ratio of 0.9:1 to 1.10:1 by weight percent.

11. The insecticidal composition according to claim 10, wherein the insecticidal composition includes, by weight percentage, 1% to 6% active ingredient; and
wherein a density of the insecticidal composition is no less than 1.0 g/mL and no greater than 1.2 g/mL. (canceled)

12. The insecticidal composition according to claim 11, wherein the insecticidal composition has a non-volatile fraction of 50 wt % to 75 wt %.

13. A method for insect control, the method comprising:
contacting a population of insects with an insecticidal composition, the insecticidal composition comprising:
an active ingredient including a sulfoximine;
a solvent system including a polyalkylene carbonate solvent and a second solvent;
a first surfactant that is an alkoxylated alcohol; and
a second surfactant that is an ethoxylated castor oil.

14. The method according to claim 13, wherein administration of the insecticidal composition provides droplets having an average diameter of less than 30 μm.

15. The method according to claim 14, wherein the insecticidal composition is applied as an aerosol or fog, and wherein the aerosol or fog contacts the population of insects.

16. The method according to claim 14, wherein the insecticidal composition is applied using an ultra low volume (ULV) sprayer.

17. The method according to claim 14, wherein the population of insects comprises mosquitos selected from the group consisting of Aedes sp., Culex sp., and Anopheles sp.

18. The method according to claim 17, wherein the insecticidal composition has a mortality rate of at least 80% against each of Aedes sp., Culex sp., and Anopheles sp. after 24 hours.

19. The method according to claim 17, wherein the insecticidal composition has a mortality rate of at least 90% against each of Aedes sp., Culex sp., and Anopheles sp. after 24 hours.

20. The method according to claim 17, wherein the insecticidal composition has a one hour knockdown rate of at least 90% against each of Aedes sp., Culex sp., and Anopheles sp.
